(19) United States
(12) Patent Application Publication
(10) Pub. No.: US 2024/0064706 A1
(43) Pub. Date: Feb. 22, 2024

(54) TRANSMISSION METHOD, TRANSMISSION APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/258,299

(22) PCT Filed: Dec. 17, 2020
(86) PCT No.: PCT/CN2020/137384

§ 371 Date: Jun. 19, 2023

(51) Int. Cl. H04W 72/04

(52) U.S. Cl. CPC H04W 72/04

(57) ABSTRACT

A transmission method includes: determining, by a terminal, a first parameter, and the first parameter is used for indicating transmission parameter information of the terminal for performing downlink channel coverage enhancement.

### CROSS-REFERENCE TO RELATED APPLICATIONS

The present application is the U.S. National Stage of International Application No. PCT/CN2020/137384, filed on Dec. 17, 2020, the contents of which are incorporated herein by reference in their entireties for all purposes.

### BACKGROUND

### Description of the Related Art

In wireless communication systems, machine type communication (MTC) and narrow band internet of things (NB-IoT) technologies have been proposed for scenarios such as low rate and high latency of IoT services.

Due to the development of IoT services, MTC and NB-IoT technologies can no longer meet the requirements for rate and latency of current IoT services. Therefore, a new terminal, reduced capability (Redcap) UE, or NR-lite for short, is designed to cover the requirements of the IoT services. Due to the requirements for low cost and low complexity of the Redcap terminal, as well as the reduction in antenna numbers and bandwidth, the coverage capacity of the terminal is reduced, and coverage enhancement is needed. However, during the coverage enhancement process, the terminal cannot determine relevant parameters for the coverage enhancement.

### SUMMARY

The present disclosure relates to the field of wireless communication technology, and in particular to a transmission method, transmission apparatus, and storage medium.

According to a first aspect of the embodiments of the present disclosure, a transmission method is provided. The method is applied to a terminal and includes determining a first parameter, where the first parameter is used for indicating transmission parameter information of the terminal for performing downlink channel coverage enhancement.

According to a second aspect of the embodiments of the present disclosure, a transmission method is provided. The method is applied to a network side and includes determining a first parameter, where the first parameter is used for indicating transmission parameter information of a terminal for performing downlink channel coverage enhancement; and sending the first parameter on a broadcast channel.

According to a third aspect of the embodiments of the present disclosure, a transmission apparatus is provided. The apparatus includes a processor and a memory, configured to store an instruction executable by the processor. The processor is configured to execute the transmission method of any one of the embodiments according to the first aspect, or to execute the transmission method of any one of the embodiments according to the second aspect.

According to a fourth aspect of the embodiments of the present disclosure, a non-transitory computer-readable storage medium is provided. An instruction in the storage medium, when executed by a processor of a mobile terminal, enables the mobile terminal to execute the transmission method of any one of the embodiments according to the first aspect, or to execute the transmission method of any one of the embodiments according to the second aspect.

It should be understood that the above general description and the later detailed description are only illustrative and explanatory and do not limit the present disclosure.

### BRIEF DESCRIPTION OF THE DRAWINGS

The accompanying drawings herein are incorporated into the specification and form a part of the specification, showing embodiments that comply with the present disclosure, and are used together with the specification to explain the principles of the present disclosure.

FIG. 1 is an architecture diagram of a communication system between a network device and a terminal illustrated according to an embodiment.

FIG. 2 is a flowchart of a transmission method illustrated according to an embodiment.

FIG. 3 is a flowchart of another transmission method illustrated according to an embodiment.

FIG. 4 is a flowchart of another transmission method illustrated according to an embodiment.

FIG. 5 is a flowchart of another transmission method illustrated according to an embodiment.

FIG. 6 is a block diagram of a transmission apparatus illustrated according to an embodiment.

FIG. 7 is a block diagram of another transmission apparatus illustrated according to an embodiment.

FIG. 8 is a block diagram of an apparatus for transmission illustrated according to an embodiment.

FIG. 9 is a block diagram of an apparatus for transmission illustrated according to an embodiment.

### DETAILED DESCRIPTION OF THE PREFERRED EMBODIMENTS

Embodiments will be explained in detail herein, examples of which are illustrated in the accompanying drawings. When the following description refers to the accompanying drawings, unless otherwise indicated, the same numbers in different drawings represent the same or similar elements. The embodiments described in the following embodiments do not represent all embodiments consistent with the present disclosure. On the contrary, they are only examples of apparatus and methods that are consistent with some aspects of the present disclosure as detailed in the attached claims.

In a communication system, for scenarios such as low rate and high latency in IoT services (e.g., meter reading, environmental monitoring, etc.), two major technologies, MTC and NB-IoT are proposed in related arts. Currently, the NB-IoT technology can support a maximum rate of several hundred K, and the MTC technology can support a maximum rate of several M. However, with the continuous development of the IoT services (e.g., monitoring, smart home, wearable devices and industrial sensor detection, etc.), tens to 100 M rates are generally required, and the requirements for latency are relatively higher. Therefore, in the communication system, the MTC and NB-IoT technologies can no longer meet the requirements of current IoT services. On the other hand, the MTC and NB-IoT technologies are generally deployed in scenarios where it is difficult to charge or replace batteries, such as basements, outdoors, and other areas, so a terminal associated with the MTC and NB-IoT technologies is limited by hardware, resulting in less coverage capacity than a general wireless communication terminal. Due to the application environment, the power saving of the device is also a characteristic of the two major technologies, MTC and NB-IoT.

Due to the development of the IoT services, the MTC and NB-IoT technologies can no longer meet the requirements for rate and delay of current IoT services. Therefore, a new terminal, reduced capability (Redcap) UE, or NR-lite for short, is designed to cover the requirements of the IoT services. Due to the requirements for low cost and low complexity of the Redcap terminal, as well as the reduction in antenna numbers and bandwidth, the coverage capacity of the terminal is reduced, and coverage enhancement is needed. In the Redcap terminal, the simulation evaluates that the broadcasting of the physical downlink control channel (PDCCH) needs to be enhanced at a first value of Hz, e.g., 4 GHz. The coverage enhancement of the broadcasting of the PDCCH may be repetition, or by using a greater aggregation level of frame structures (control channel elements, CCE), etc.

In the use of coverage enhancement means, the reception of the terminal is affected. For example, in the use of repetition, the terminal needs to determine information related to the repetition to determine the monitoring timing of the broadcasting of the PDCCH. Or, in the case where a greater CCE aggregation level is used, the terminal needs to determine information related to the CCE aggregation level for the determination of the object to be monitored of the broadcasting of the PDCCH. However, there is no method in the related arts for how to indicate a terminal to determine a relevant parameter of coverage enhancement. Therefore, the present disclosure provides a transmission method for indicating a terminal to determine a relevant parameter of coverage enhancement and thus determine the monitoring timing or the object to be monitored of the broadcasting of the PDCCH.

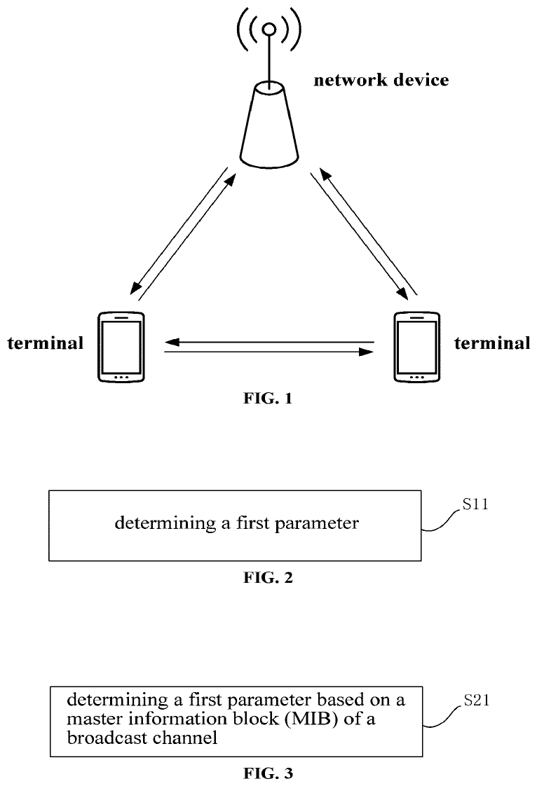

The present disclosure provides a transmission method, transmission apparatus, and storage medium. FIG. 1 is an architecture diagram of a communication system between a network device and a terminal illustrated according to an embodiment. The transmission method provided by the present disclosure may be applied in the architecture diagram of the communication system shown in FIG. 1. As shown in FIG. 1, the terminal may receive a transmission configuration parameter sent by the network device to determine the monitoring timing or the object to be monitored of the broadcasting of the PDCCH.

It can be understood that the communication system between the network device and the terminal shown in FIG. 1 is only a schematic explanation, and the wireless communication system may also include other network devices, such as a core network device, wireless relay device, and wireless return device, which are not shown in FIG. 1. The embodiments of the present disclosure do not limit the number of the network device and the terminal included in the wireless communication system.

It can be further understood that the wireless communication system of the embodiments of the present disclosure is a network that provides wireless communication functions. The wireless communication system may adopt different communication technologies, such as code division multiple access (CDMA), wideband code division multiple access (WCDMA), time division multiple access (TDMA), frequency division multiple access (FDMA), orthogonal frequency division multiple access (OFDMA), single carrier FDMA (SC-FDMA), and carrier sense multiple access with collision avoidance. According to factors such as capacity, rate, and latency of different networks, networks may be divided into 2G (generation) networks, 3G networks, 4G networks, or future evolution networks, such as 5G networks. The 5G networks may also be referred to as new radio (NR) networks. For the convenience of description, the wireless communication network is sometimes referred to as a network in the present disclosure.

Furthermore, the network device involved in the present disclosure may also be referred to as a wireless access network device. The wireless access network device may be: a base station, an evolved node B (base station), a home base station, an access point (AP) in a wireless fidelity (WIFI) system, a wireless relay node, a wireless return node, a transmission point (TP) or a transmission and reception point (TRP), and so on; or the wireless access network device may also be a gNB in a NR system, or a component or part of a base station, etc. The network device may also be an in-vehicle device when the communication system is a vehicle-to-vehicle (V2X) communication system. It should be understood that in the embodiments of the present disclosure, the specific technology and the specific device form used for the network device are not limited.

Furthermore, the terminal involved in the present disclosure may also be referred to as a terminal device, user equipment (UE), mobile station (MS), mobile terminal (MT), etc., which is a device that provides voice and/or data connectivity to a user. For example, the terminal may be a handheld device or an in-vehicle device, etc., with a function of wireless connectivity. Currently, some examples of the terminal are: a mobile phone, a pocket personal computer (PPC), a palmtop computer, a personal digital assistant (PDA), a notebook computer, a tablet computer, a wearable device, or an in-vehicle device. In addition, the terminal device may also be an in-vehicle device when the communication system is a V2X communication system. It should be understood that in the embodiments of the present disclosure, the specific technology and the specific device form used for the terminal are not limited.

FIG. 2 is a flowchart of a transmission method illustrated according to an embodiment. As shown in FIG. 2, the transmission method is applied to a terminal and includes the following step S11.

In the step S11, a first parameter is determined.

In the embodiments of the present disclosure, the terminal may be a Redcap UE, and may be other types of terminals, and the present disclosure is not specifically limited herein.

In some embodiments of the present disclosure, the first parameter is used for indicating transmission parameter information of the terminal for performing downlink channel coverage enhancement. In the case where the terminal is a Redcap UE, for example, when the terminal performs the coverage enhancement, for example, using means such as repetition, a greater CCE aggregation level, etc., the terminal may determine the first parameter based on a broadcast channel, and determine, based on the first parameter, the transmission parameter information of the network side for performing the coverage enhancement.

In the transmission method provided by the present disclosure, the terminal determines the detected PDCCH by determining the transmission parameter for coverage enhancement and receives the transmission data based on the detected PDCCH to obtain the required information and to avoid missing part of the transmission data.

In some embodiments of the present disclosure, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment of the transmission method in the present disclosure, the search space parameter includes a control channel element (CCE) aggregation level detected by the terminal. The terminal detects the PDCCH based on the CCE aggregation level. For example, the degree of the CCE aggregation level is determined based on the search space parameter, or whether it is the maximum CCE aggregation level, such as 32 CCEs, is determined based on the search space parameter. The terminal receives the required data based on the determined CCE aggregation level.

In one embodiment of the transmission method of the present disclosure, the terminal determines the CCE aggregation level based on a search space pattern. Herein, different search space patterns correspond to different CCE aggregation levels. It is understood that the correspondence between the search space pattern and the CCE aggregation level may be specified by a protocol or pre-configured.

In the transmission method provided by the present disclosure, the terminal determines a monitoring timing for the broadcasting of the PDCCH, or determines an object to be monitored. Based on the determined monitoring timing of the broadcasting of the PDCCH or the determined object to be monitored, the terminal detects the PDCCH to receive transmission data, and partial loss of the transmission data can be avoided.

FIG. 3 is a flowchart of a transmission method illustrated according to an embodiment. As shown in FIG. 3, the transmission method is applied to a terminal and includes the following step S21.

In the step S21, the first parameter is determined based on a master information block (MIB) of a broadcast channel.

In some embodiments of the present disclosure, the network side sends a first parameter based on a MIB of a broadcast channel. The terminal determines the first parameter based on the MIB of the network side. Herein, the MIB includes a spare bit. The network side may carry the first parameter in the spare bit.

In some embodiments of the present disclosure, the terminal receives the MIB and determines the first parameter based on the spare bit included in the MIB.

In the transmission method provided by the present disclosure, the terminal determines, based on the spare bit, a number of a repeated PDCCH transmission during a PDCCH monitoring period. For example, the set of the optional number of the repeated transmission in the predefined broadcasting of the PDCCH in the MIB is (M, N), in other words, when broadcasting the PDCCH in the MIB, M times or N times of a repeated transmission may be selected. The network side may indicate, based on the spare bit in the MIB, the selected number of the repeated transmission when broadcasting the PDCCH in the MIB, for example, using 1 to indicate that the number of the repeated transmission when broadcasting the PDCCH is M, and using 0 to indicate that the number of the repeated transmission when broadcasting the PDCCH is N, which is only an example and is not a specific limitation of the present disclosure.

In the transmission method provided by the present disclosure, the terminal determines the parameter related to the CCE aggregation level based on the spare bit in the MIB. The parameter related to the CCE aggregation level may be different search space patterns. For example, the optional search space patterns in the predefined broadcasting of the PDCCH include search space pattern 1 and search space pattern 2. The terminal may determine the search space pattern to be used based on the spare bit in the MIB. For example, a spare bit of 1 determines that search space pattern 1 is used, and a spare bit of 0 determines that search space pattern 2 is used, which is only an example and is not a specific limitation of the present disclosure.

In some embodiments of the present disclosure, the network side sends a first parameter based on a MIB of a broadcast channel. The terminal determines the first parameter based on the MIB of the network side. Herein, the MIB includes a reserve bit. The network side may carry the first parameter in the reserve bit.

In some embodiments of the present disclosure, the terminal receives the MIB and determines the first parameter based on the reserve bit included in the MIB.

In one embodiment of the present disclosure, the reserve bit includes at least one bit. For example, in response to using one reserve bit in the received MIB to indicate the first parameter, it is determined that the set of the optional number of the repeated transmission in the predefined broadcasting of the PDCCH in the MIB includes two optional number of the repeated transmission. In response to using two reserve bits in the received MIB to indicate the first parameter, it is determined that the set of the optional number of the repeated transmission in the predefined broadcasting of the PDCCH in the MIB includes four optional number of the repeated transmission. The reserve bit may be a reserve bit that exists in kssb in the frequency range 1 (FR1).

In one embodiment of the present disclosure, the first parameter includes a search space parameter, and the search space parameter may be determined based on the reserve bit in the MIB. For example, a reserve bit of 1 determines that search space pattern 1 is used, and a reserve bit of 0 determines that search space pattern 2 is used, which is only an example and is not a specific limitation of the present disclosure.

In the transmission method provided by the present disclosure, the first parameter may be multiplexed in an existing information field in the MIB.

In one embodiment of the present disclosure, the existing information field in the MIB may be a field for indicating information related to a synchronization signal block (SSB) frequency offset. The terminal determines the first parameter based on the field for indicating the information related to the SSB frequency offset.

In the transmission method provided by the present disclosure, the existing information field in the MIB may be a field for indicating time-frequency position related information of CORESET #0. The terminal determines the first parameter based on the field of the MIB for indicating the time-frequency position related information of CORESET #0.

In one embodiment of the present disclosure, it can be understood that for a MIB, including a MIB of a low capacity terminal, the first parameter may be determined based on the existing information field in the MIB.

In one embodiment of the present disclosure, the downlink channel is a broadcast channel.

The transmission method provided in the embodiments of the present disclosure may be applied to FR1, FR2, time division duplexing (TDD), or frequency division duplex (FDD), which is only an example and is not a specific limitation of the present disclosure. The above embodiment may be implemented separately and together with any other embodiment of the present disclosure.

Based on the same concept, one embodiment of the present disclosure also provides a transmission method.

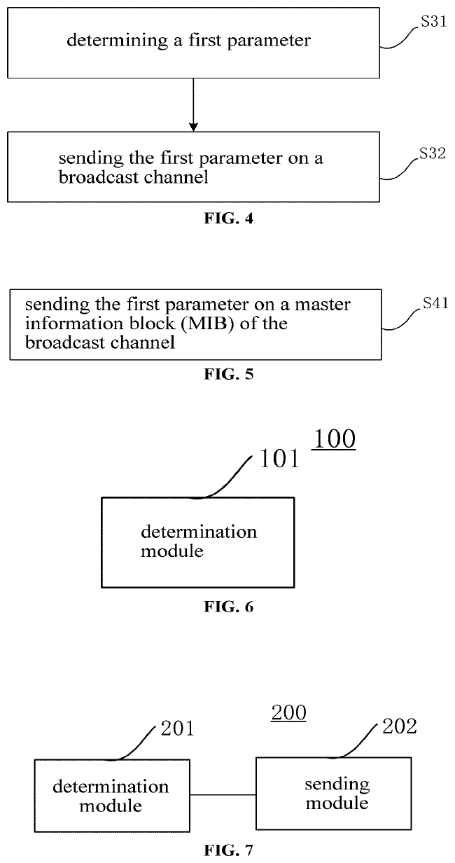

FIG. 4 is a flowchart of a transmission method illustrated according to an embodiment. As shown in FIG. 4, the transmission method is applied to a network side and includes the following steps S31 to S32.

In the step S31, a first parameter is determined.

In the embodiments of the present disclosure, the first parameter is used for indicating transmission parameter information of a terminal for performing downlink channel coverage enhancement.

In the step S32, the first parameter is sent on a broadcast channel.

In some embodiments of the present disclosure, the first parameter is used for indicating transmission parameter information of the terminal for performing downlink channel coverage enhancement. In the case where the terminal is a Redcap UE, for example, when the terminal performs the coverage enhancement, for example, using means such as repetition, a greater CCE aggregation level, etc., the terminal may determine the first parameter based on a broadcast channel, and determine, based on the first parameter, the parameter of the network side for performing the coverage enhancement.

In the transmission method provided by the present disclosure, by determining the coverage enhancement parameter, the terminal may be indicated to determine the monitoring timing of the broadcasting of the PDCCH, or the object to be monitored. The terminal determines the detected PDCCH based on the first parameter, enabling the terminal to better receive the transmitted data.

In some embodiments of the present disclosure, the transmission parameter information may include one or a combination of:
a number of a time unit for continuous PDCCH monitoring during a PDCCH monitoring period;
a number of a repeated PDCCH transmission during the PDCCH monitoring period; or
a search space parameter.

In one embodiment of the transmission method in the present disclosure, the search space parameter includes a CCE aggregation level detected by the terminal. The terminal detects the PDCCH based on the CCE aggregation level. For example, the degree of the CCE aggregation level is determined based on the search space parameter, or whether it is the maximum CCE aggregation level, such as 32 CCEs, is determined based on the search space parameter. The terminal receives the required data based on the determined CCE aggregation level.

In one embodiment of the transmission method of the present disclosure, the terminal determines the CCE aggregation level based on a search space pattern. Herein, different search space patterns correspond to different CCE aggregation levels. It is understood that the correspondence between the search space pattern and the CCE aggregation level may be specified by a protocol or pre-configured.

FIG. 5 is a flowchart of a transmission method illustrated according to an embodiment. As shown in FIG. 5, sending the first parameter on the broadcast channel includes the following step S41.

In the step S41, the first parameter is sent on a MIB of the broadcast channel.

In some embodiments of the present disclosure, the network side sends a first parameter based on a MIB of a broadcast channel. The terminal determines the first parameter based on the MIB of the network side. Herein, the MIB includes a spare bit. The network side may carry the first parameter in the spare bit.

In some embodiments of the present disclosure, the terminal receives the MIB and determines the first parameter based on the spare bit included in the MIB.

In the transmission method provided by the present disclosure, the network side indicates, based on the spare bit, a number of a repeated PDCCH transmission during a PDCCH monitoring period. For example, the set of the optional number of the repeated transmission in the predefined broadcasting of the PDCCH in the MIB is (M, N), in other words, when broadcasting the PDCCH in the MIB, M times or N times of a repeated transmission may be selected. The network side may indicate, based on the spare bit in the MIB, the selected number of the repeated transmission when broadcasting the PDCCH in the MIB, for example, using 1 to indicate that the number of the repeated transmission when broadcasting the PDCCH is M, and using 0 to indicate that the number of the repeated transmission when broadcasting the PDCCH is N, which is only an example and is not a specific limitation of the present disclosure.

In the transmission method provided by the present disclosure, the network side indicates the parameter related to the CCE aggregation level based on the spare bit in the MIB. The parameter related to the CCE aggregation level may be different search space patterns. For example, the optional search space patterns in the predefined broadcasting of the PDCCH include search space pattern 1 and search space pattern 2. The search space pattern to be used may be determined based on the spare bit in the MIB. For example, a spare bit of 1 indicates that search space pattern 1 is used, and a spare bit of 0 indicates that search space pattern 2 is used, which is only an example and is not a specific limitation of the present disclosure.

In some embodiments of the present disclosure, the network side sends a first parameter based on a MIB of a broadcast channel. The terminal determines the first parameter based on the MIB of the network side. Herein, the MIB includes a reserve bit. The network side may carry the first parameter in the reserve bit.

In some embodiments of the present disclosure, the terminal receives the MIB and determines the first parameter based on the reserve bit included in the MIB.

In one embodiment of the present disclosure, the reserve bit includes at least one bit. For example, in response to determining that the set of the optional number of the repeated transmission in the predefined broadcasting of the PDCCH in the MIB includes at least two optional number of the repeated transmission, the network side determines to use at least one bit in the reserve bit to indicate the first parameter. In response to determining that the set of the optional number of the repeated transmission in the predefined broadcasting of the PDCCH in the MIB includes at least four optional number of the repeated transmission, the network side determines to use at least two bits in the reserve bit to indicate the first parameter. The reserve bit may be a reserve bit that exists in kssb in the frequency range 1 (FR1).

In one embodiment of the present disclosure, the first parameter includes a search space parameter, and the search space parameter may be carried in the reserve bit in the MIB. For example, a reserve bit of 1 indicates that search space pattern 1 is used, and a reserve bit of 0 indicates that search space pattern 2 is used, which is only an example and is not a specific limitation of the present disclosure.

In the transmission method provided by the present disclosure, the first parameter may be carried in an existing information field in the MIB.

In one embodiment of the present disclosure, the existing information field in the MIB may be a field for indicating information related to a SSB frequency offset. The network side may carry the first parameter in the field of the MIB for indicating the information related to the SSB frequency offset.

In the transmission method provided by the present disclosure, the existing information field in the MIB may be a field for indicating time-frequency position related information of CORESET #0. The network side may carry the first parameter in the field of the MIB for indicating the time-frequency position related information of CORESET #0.

In one embodiment of the present disclosure, it can be understood that for a MIB, including a MIB of a low capacity terminal, the first parameter may be sent based on the existing information field in the MIB.

In one embodiment of the present disclosure, the downlink channel is the broadcast channel.

The transmission method provided in the embodiments of the present disclosure may be applied to FR1, FR2, TDD, and FDD. which is only an example and is not a specific limitation of the present disclosure. The above embodiment may be implemented separately and together with any other embodiment of the present disclosure.

The transmission method provided by the embodiments of the present disclosure is used for determining the PDCCH transmission parameter information, and the terminal determines the object to be monitored based on the PDCCH transmission parameter information.

The network side may transmit in the MIB transmission parameter information of the broadcasting of the PDCCH, and the transmission parameter information includes at least a parameter for coverage enhancement.

The parameter for coverage enhancement may be a number of a time unit for continuous monitoring during a broadcasting PDCCH monitoring period, a number of a repeated transmission during a monitoring period, or a search space related parameter.

The search space related parameter includes the monitored CCE aggregation level, such as the maximum CCE aggregation level.

The spare bit in the MIB may be used to indicate the transmission parameter. For example, if the optional number of the repeated transmission in the predefined broadcasting of the PDCCH is (M, N), the spare bit in the MIB may indicate that either M or N is currently used. For example, optional search space pattern 1 and search space pattern 2 are predefined in the broadcasting of the PDCCH, different search space patterns contain different CCE aggregation levels. The spare bit may indicate the use.

The reserve bit in the MIB may be used to indicate the transmission parameter. Specifically, there are two unused reserve bits in Kssb in FR1, the two bits may be used to indicate that (6) is based on (1), and the existing information field in the MIB may be rewritten for indication.

The MIB information field that may be multiplexed may be the SSB that indicates the SSB frequency offset, or may be the information field that indicates the time-frequency position related information of CORESET #0.

The transmission method provided in the embodiments of the present disclosure may be applied to FR1, FR2, TDD, or FDD, which is only an example and is not a specific limitation of the present disclosure. The above embodiment may be implemented separately and together with any other embodiment of the present disclosure.

Based on the same concept, one embodiment of the present disclosure also provides a transmission apparatus.

It can be understood that the transmission apparatus provided in the embodiments of the present disclosure includes hardware structures and/or software modules corresponding to the execution of each function in order to achieve the above functions. Combining the units and algorithm steps of each example disclosed in the embodiments of the present disclosure, the embodiments of the present disclosure may be implemented in the form of hardware or a combination of hardware and computer software. Whether a certain function is executed in hardware or computer software driven hardware depends on the specific application and design constraints of the technical solution. Those skilled in the art may use different methods to implement the described functions for each specific application, but such implementation should not be considered beyond the scope of the technical solution of the embodiments of the present disclosure.

FIG. 6 is a block diagram of a transmission apparatus illustrated according to an embodiment. Referring to FIG. 6, the transmission apparatus 100 is applied to a terminal and includes a determination module 101.

The determination module 101 is configured to determine a first parameter, and the first parameter is used for indicating transmission parameter information of a terminal for performing downlink channel coverage enhancement.

In one embodiment of the present disclosure, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment of the present disclosure, the search space parameter includes a control channel element (CCE) aggregation level.

In one embodiment of the present disclosure, the search space parameter includes a search space pattern, and different search space patterns correspond to different CCE aggregation levels.

In one embodiment of the present disclosure, the first parameter is determined based on a master information block (MIB) of the broadcast channel.

In one embodiment of the present disclosure, the first parameter is carried in a spare bit of the MIB.

In one embodiment of the present disclosure, the spare bit is used for indicating a parameter related to a number of a repeated transmission; or

the spare bit is used for indicating a parameter related to a CCE aggregation level;

and different search space patterns correspond to different CCE aggregation levels.

In one embodiment of the present disclosure, the first parameter is carried in a reserve bit of the MIB.

In one embodiment of the present disclosure, the first parameter is carried in a field of the MIB for indicating information related to a SSB frequency offset; or

the first parameter is carried in a field of the MIB for indicating time-frequency position related information of CORESET #0.

In one embodiment of the present disclosure, the downlink channel is the broadcast channel.

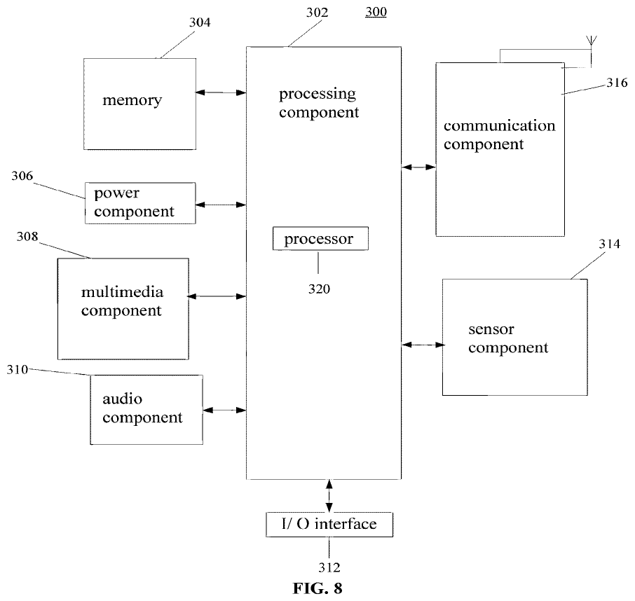

FIG. 7 is a block diagram of a transmission apparatus illustrated according to an embodiment. Referring to FIG. 7, the transmission apparatus 200 is applied to a network side and includes a determination module 201 and a sending module 202.

The determination module 201 is configured to determine a first parameter, and the first parameter is used for indicating transmission parameter information of a terminal for performing downlink channel coverage enhancement. The sending module 202 is configured to send the first parameter on a broadcast channel.

In one embodiment of the present disclosure, the transmission parameter information includes one or a combination of:
a number of a time unit for continuous PDCCH monitoring during a PDCCH monitoring period;
a number of a repeated PDCCH transmission during the PDCCH monitoring period; or
a search space parameter.

In one embodiment of the present disclosure, the search space parameter includes a control channel element (CCE) aggregation level.

In one embodiment of the present disclosure, the search space parameter includes a search space pattern, and different search space patterns correspond to different CCE aggregation levels.

In one embodiment of the present disclosure, the sending module 202 is configured to send the first parameter on a master information block (MIB) of the broadcast channel.

In one embodiment of the present disclosure, the first parameter is carried in a spare bit of the MIB.

In one embodiment of the present disclosure, the spare bit is used for indicating a parameter related to a number of a repeated transmission; or
the spare bit is used for indicating a parameter related to a CCE aggregation level; and different search space patterns correspond to different CCE aggregation levels.

In one embodiment of the present disclosure, the first parameter is carried in a reserve bit of the MIB.

In one embodiment of the present disclosure, the first parameter is carried in a field of the MIB for indicating information related to a SSB frequency offset; or

the first parameter is carried in a field of the MIB for indicating time-frequency position related information of CORESET #0.

In one embodiment of the present disclosure, the downlink channel is the broadcast channel.

With respect to the apparatus in the above embodiments, the specific manner in which the individual modules perform their operations has been described in detail in the embodiments relating to the method and will not be described in detail herein.

FIG. 8 is a block diagram of an apparatus 300 for transmission illustrated according to an embodiment. For example, the apparatus 300 may be a cell phone, a computer, a digital broadcast terminal, a message sending and receiving device, a gaming console, a tablet device, a medical device, a fitness device, a personal digital assistant, etc.

Referring to FIG. 8, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the apparatus 300, such as operations associated with display, telephone call, data communication, camera operation, and recording operation. The processing component 302 may include one or more processors 320 to execute instructions to complete all or some of the steps of the method described above. In addition, the processing component 302 may include one or more modules that facilitate interaction between the processing component 302 and other components. For example, the processing component 302 may include a multimedia module to facilitate interaction between the multimedia component 308 and the processing component 302.

The memory 304 is configured to store various types of data to support operations at the apparatus 300. Examples of such data include the following for any application or method to operate on the apparatus 300: instructions, contact data, phonebook data, messages, pictures, videos, etc. The memory 304 may be implemented by any type of volatile or non-volatile storage device or a combination thereof, such as static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or CD-ROM.

The power supply component 306 provides power to various components of the apparatus 300. The power supply component 306 may include a power management system, one or more power supplies, and other components associated with generating, managing, and distributing power for the apparatus 300.

The multimedia component 308 includes a screen that provides an output interface between the apparatus 300 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of the touch or swipe action, but also detect the duration and pressure associated with the touch or swipe action. In some embodiments, the multimedia component 308 includes a front-facing camera and/or a rear-facing camera. The front-facing camera and/or rear-facing camera may receive external multimedia data when the apparatus 300 is in an operating mode, such as a shooting mode or a video mode. Each front-facing camera and rear-facing camera may be a fixed optical lens system or have a focal length and optical zoom capability.

The audio component 310 is configured to output and/or input audio signals. For example, the audio component 310 includes a microphone (MIC) configured to receive external audio signals when the apparatus 300 is in an operating mode, such as a call mode, a recording mode, and a voice recognition mode. The received audio signals may be further stored in the memory 304 or sent via the communication component 316. In some embodiments, the audio component 310 further includes a speaker for outputting the audio signals.

The I/O interface 312 provides an interface between the processing component 302 and a peripheral interface module, and the peripheral interface module may be a keypad, a click wheel, a button, etc. These buttons may include, but are not limited to: a home button, a volume button, a start button, and a lock button.

The sensor component 314 includes one or more sensors, used for providing a status assessment of various aspects of the apparatus 300. For example, the sensor component 314 may detect an open/closed state of the apparatus 300, relative positioning of the component, for example, the component is the display and keypad of the apparatus 300, the sensor component 314 may also detect a change in the position of the apparatus 300 or a change in the position of one component of the apparatus 300, the presence or absence of user contact with the apparatus 300, the orientation or acceleration/deceleration of the apparatus 300, and temperature changes of the apparatus 300. The sensor component 314 may include a proximity sensor configured to detect the presence of nearby objects in the absence of any physical contact. The sensor component 314 may also include a light sensor, such as a CMOS or CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate communication between the apparatus 300 and other devices by wired or wireless means. The apparatus 300 may access a wireless network based on a communication standard such as WiFi, 2G or 3G, or a combination thereof. In one embodiment, the communication component 316 receives broadcast signals or broadcast-related information from an external broadcast management system via a broadcast channel. In an embodiment, the communication component 316 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In one embodiment, the apparatus 300 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the above method.

In one embodiment, a non-transitory computer-readable storage medium including an instruction is provided, such as a memory 304 including an instruction, the instruction being executable by the processor 320 of the apparatus 300 to complete the above method. For example, the non-transitory computer-readable storage medium may be a ROM, a random access memory (RAM), a CD-ROM, a magnetic tape, a floppy disk, an optical data storage device, etc.

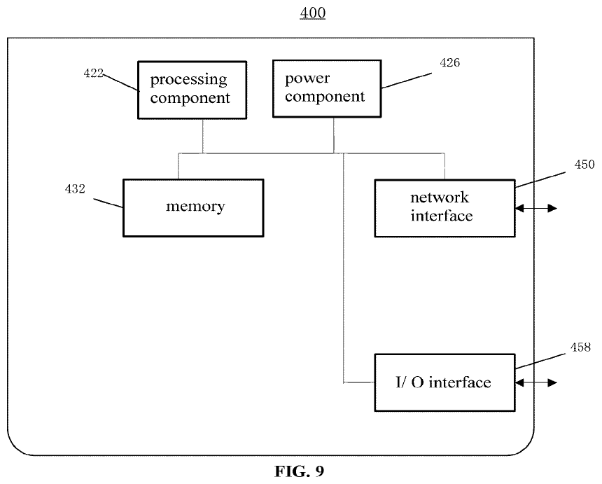

FIG. 9 is a block diagram of an apparatus 400 for transmission illustrated according to an embodiment. For example, the apparatus 400 may be provided as a server. Referring to FIG. 9, the apparatus 400 includes a processing component 422, which further includes one or more processors, and a memory resource represented by a memory 432 for storing an instruction, such as an application program, that may be executed by the processing component 422. The application program stored in the memory 432 may include one or more modules, and each module corresponds to a set of the instruction. In addition, the processing component 422 is configured to execute the instruction to perform the transmission method described above.

The apparatus 400 may also include a power component 426 configured to perform power management of the apparatus 400, a wired or wireless network interface 450 configured to connect the apparatus 400 to a network, and an input/output (I/O) interface 458. The apparatus 400 may operate an operating system stored in the memory 432, such as Windows Server™, Mac OS X™, Unix™, Linux™, FreeBSD™, or the like.

According to a first embodiment of the present disclosure, a transmission method is provided. The method is applied to a terminal and includes determining a first parameter, where the first parameter is used for indicating transmission parameter information of the terminal for performing downlink channel coverage enhancement.

In one embodiment, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment, the search space parameter includes a control channel element (CCE) aggregation level.

In one embodiment, the search space parameter includes a search space pattern, and different search space patterns correspond to different CCE aggregation levels.

In one embodiment, the first parameter is determined based on a master information block (MIB) of a broadcast channel.

In one embodiment, the first parameter is carried in a spare bit of the MIB.

In one embodiment, the spare bit is used for indicating a parameter related to a number of a repeated transmission or the spare bit is used for indicating a parameter related to a CCE aggregation level; and different search space patterns correspond to different CCE aggregation levels.

In one embodiment, the first parameter is carried in a reserve bit of the MIB.

In one embodiment, the first parameter is carried in a field of the MIB for indicating information related to a synchronization signal block (SSB) frequency offset; or
the first parameter is carried in a field of the MIB for indicating time-frequency position related information of CORESET #0.

In one embodiment, the downlink channel is a broadcast channel.

According to a second embodiment of the present disclosure, a transmission method is provided. The method is applied to a network side and includes determining a first parameter, where the first parameter is used for indicating transmission parameter information of a terminal for performing downlink channel coverage enhancement; and sending the first parameter on a broadcast channel.

In one embodiment, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment, the search space parameter includes a control channel element (CCE) aggregation level.

In one embodiment, the search space parameter includes a search space pattern, and different search space patterns correspond to different CCE aggregation levels.

In one embodiment, the sending the first parameter on the broadcast channel includes sending the first parameter on a master information block (MIB) of the broadcast channel.

In one embodiment, the first parameter is carried in a spare bit of the MIB.

In one embodiment, the spare bit is used for indicating a parameter related to a number of a repeated transmission or the spare bit is used for indicating a parameter related to a CCE aggregation level; and different search space patterns correspond to different CCE aggregation levels.

In one embodiment, the first parameter is carried in a reserve bit of the MIB.

In one embodiment, the first parameter is carried in a field of the MIB for indicating information related to a synchronization signal block (SSB) frequency offset or the first parameter is carried in a field of the MIB for indicating time-frequency position related information of CORESET #0.

In one embodiment, the downlink channel is the broadcast channel.

According to a third embodiment of the present disclosure, a transmission apparatus is provided. The apparatus is applied to a terminal and includes:

a determination module, configured to determine a first parameter, where the first parameter is used for indicating transmission parameter information of the terminal for performing downlink channel coverage enhancement.

In one embodiment, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment, the search space parameter includes a control channel element (CCE) aggregation level.

In one embodiment, the search space parameter includes a search space pattern, and different search space patterns correspond to different CCE aggregation levels.

In one embodiment, the first parameter is determined based on a master information block (MIB) of a broadcast channel.

In one embodiment, the first parameter is carried in a spare bit of the MIB.

In one embodiment, the spare bit is used for indicating a parameter related to a number of a repeated transmission; or
the spare bit is used for indicating a parameter related to a CCE aggregation level; and different search space patterns correspond to different CCE aggregation levels.

In one embodiment, the first parameter is carried in a reserve bit of the MIB.

In one embodiment, the first parameter is carried in a field of the MIB for indicating information related to a synchronization signal block (SSB) frequency offset; or
the first parameter is carried in a field of the MIB for indicating time-frequency position related information of CORESET #0.

In one embodiment, the downlink channel is a broadcast channel.

According to a fourth embodiment of the present disclosure, a transmission apparatus is provided. The apparatus is applied to a network side and includes a determination module, configured to determine a first parameter, where the first parameter is used for indicating transmission parameter information of a terminal for performing downlink channel coverage enhancement, and a sending module, configured to send the first parameter on a broadcast channel.

In one embodiment, the transmission parameter information includes one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

In one embodiment, the search space parameter includes a control channel element (CCE) aggregation level.

In one embodiment, the search space parameter includes a search space pattern, and different search space patterns correspond to different CCE aggregation levels.

In one embodiment, the sending module is configured to send the first parameter on a master information block (MIB) of the broadcast channel.

In one embodiment, the first parameter is carried in a spare bit of the MIB.

In one embodiment, the spare bit is used for indicating a parameter related to a number of a repeated transmission or the spare bit is used for indicating a parameter related to a CCE aggregation level, and different search space patterns correspond to different CCE aggregation levels.

In one embodiment, the first parameter is carried in a reserve bit of the MIB.

In one embodiment, the first parameter is carried in a field of the MIB for indicating information related to a synchronization signal block (SSB) frequency offset or the first parameter is carried in a field of the MIB for indicating time-frequency position related information of CORESET #0.

In one embodiment, the downlink channel is the broadcast channel.

According to a fifth embodiment of the present disclosure, a transmission apparatus is provided. The apparatus includes a processor and a memory configured to store an instruction executable by the processor. The processor is configured to execute the transmission method of any one of the embodiments according to the first embodiment, or to execute the transmission method of any one of the embodiments according to the second embodiment.

According to a sixth embodiment of the present disclosure, a non-transitory computer-readable storage medium is provided. An instruction in the storage medium, when executed by a processor of a mobile terminal, enables the mobile terminal to execute the transmission method of any one of the embodiments according to the first embodiment, or to execute the transmission method of any one of the embodiments according to the second embodiment.

The embodiments of the present disclosure provide technical solutions that may include the following beneficial effects: the terminal may determine the transmission parameter for the downlink channel coverage enhancement, detect the PDCCH based on the transmission parameter for the coverage enhancement to obtain the required transmission data, and to avoid missing part of the transmission data.

It is further understood that “more” in the present disclosure refers to two or more, and other quantifiers are similar. “And/or” describes the association of associated objects, and indicates that three relationships may exist, e.g., A and/or B, which may indicate the presence of A alone, the presence of both A and B, and the presence of B alone. The character “/” generally indicates that the associated objects are an “or” relationship. The singular forms “a”, “the” and “said” are also intended to include multiple forms, unless the context clearly indicates otherwise.

It is further understood that the terms “first”, “second” and the like are used to describe various types of information, but that such information should not be limited to these terms. These terms are used only to distinguish information of the same type from one another and do not indicate a particular order or level of importance. In fact, the expressions “first” and “second” may be used interchangeably. For example, without departing from the scope of the present disclosure, the first information may also be referred to as the second information, and similarly, the second information may also be referred to as the first information.

It is further understood that in the embodiments of the present disclosure, although the operations are depicted in the accompanying drawings in a particular order, it should not be understood as requiring the execution of these operations in the specific or serial order shown, or requiring the execution of all shown operations to obtain the desired results. In specific environments, multitasking and parallel processing may be advantageous.

After considering the specification and practicing the embodiments of the present disclosure, those skilled in the art will easily come up with other embodiments of the present disclosure. The purpose of the present disclosure is to cover any variations, uses, or adaptations of the present disclosure, which follow the general principles of the present disclosure and include common knowledge or commonly used technical means in the technical field that are not disclosed in the present disclosure. The specification and embodiments are only considered to be examples, and the true scope and spirit of the present disclosure are indicated by the following claims.

It should be understood that the present disclosure is not limited to the precise structure already described above and shown in the accompanying drawings, and various modifications and changes may be made without departing from the scope of the present disclosure. The scope of the present disclosure is limited only by the accompanying claims.

1. A transmission method, comprising:
determining, by a terminal, a first parameter, wherein the first parameter is used for indicating transmission parameter information of the terminal for performing downlink channel coverage enhancement.

2. The method according to claim 1, wherein the transmission parameter information comprises one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

3. The method according to claim 2, wherein the search space parameter comprises a control channel element (CCE) aggregation level; and
the search space parameter comprises a search space pattern, and different search space patterns correspond to different CCE aggregation levels.

4. (canceled)

5. The method according to claim 1, wherein the determining the first parameter comprises:
determining the first parameter based on a master information block (MIB) of a broadcast channel.

6. The method according to claim 5, wherein the first parameter is carried in a spare bit of the MIB.

7. The method according to claim 6, wherein the spare bit is used for indicating a parameter related to a number of a repeated transmission; or
the spare bit is used for indicating a parameter related to a CCE aggregation level; and different search space patterns correspond to different CCE aggregation levels.

8. The method according to claim 5, wherein the first parameter is carried in a reserve bit of the MIB.

9. The method according to claim 5, wherein the first parameter is carried in a field of the MIB for indicating information related to a synchronization signal block (SSB) frequency offset; or
the first parameter is carried in a field of the MIB for indicating time-frequency position related information of CORESET #0.

10. The method according to claim 1, wherein the downlink channel is a broadcast channel.

11. A transmission method, comprising:
determining, by a network device, a first parameter, wherein the first parameter is used for indicating transmission parameter information of a terminal for performing downlink channel coverage enhancement; and
sending, by the network device, the first parameter on a broadcast channel.

12. The method according to claim 11, wherein the transmission parameter information comprises one or a combination of:
a number of a time unit for continuous physical downlink control channel (PDCCH) monitoring during a PDCCH monitoring period;
a number of a repeated PDCCH transmission during the PDCCH monitoring period; or
a search space parameter.

13. The method according to claim 12, wherein the search space parameter comprises a control channel element (CCE) aggregation level; and
the search space parameter comprises a search space pattern, and different search space patterns correspond to different CCE aggregation levels.

14. (canceled)

15. The method according to claim 11, wherein the sending the first parameter on the broadcast channel comprises:
sending the first parameter on a master information block (MIB) of the broadcast channel.

16. The method according to claim 15, wherein the first parameter is carried in a spare bit of the MIB.

17. The method according to claim 16, wherein the spare bit is used for indicating a parameter related to a number of a repeated transmission; or
the spare bit is used for indicating a parameter related to a CCE aggregation level; and different search space patterns correspond to different CCE aggregation levels.

18. The method according to claim 15, wherein the first parameter is carried in a reserve bit of the MIB.

19. The method according to claim 15, wherein the first parameter is carried in a field of the MIB for indicating information related to a synchronization signal block (SSB) frequency offset; or
the first parameter is carried in a field of the MIB for indicating time-frequency position related information of CORESET #0.

20. The method according to claim 11, wherein the downlink channel is the broadcast channel.

21-22. (canceled)

23. A transmission apparatus, comprising:
a processor; and
a memory, configured to store an instruction executable by the processor; wherein
the processor, through executing the instruction, is configured to:
determine a first parameter, wherein the first parameter is used for indicating transmission parameter information of the terminal for performing downlink channel coverage enhancement.

24. (canceled)

25. A transmission apparatus, comprising:
a processor; and
a memory, configured to store an instruction executable by the processor; wherein
the processor, through executing the instruction, is configured to execute the transmission method according claim 11.
